(19) United States
(12) Patent Application Publication
(10) Pub. No.: US 2021/0398159 A1
(43) Pub. Date: Dec. 23, 2021

(54) DATA COLLECTION SYSTEM FOR MACHINE LEARNING

(71) Applicant: Toyota Jidosha Kabushiki Kaisha, Toyota-shi (JP)

(72) Inventors: Keisuke Nagasaka, Gotemba-shi (JP); Daiki Yokoyama, Gotemba-shi (JP)

(21) Appl. No.: 17/347,844

(22) Filed: Jun. 15, 2021

(30) Foreign Application Priority Data
Jun. 18, 2020 (JP) 2020-104956

(51) Int. Cl. G06Q 30/02; G07C 5/08; G07C 5/00; G05B 13/02; G06F 3/01

(52) U.S. Cl. CPC G06Q 30/0215; G07C 5/085; G06F 3/01; G05B 13/0265; G06Q 30/0236; G07C 5/008

(57) ABSTRACT

A data collection system for machine learning that is configured to collect data containing personal information from vehicles while administrating the collected personal information tightly. The data collection system comprises a control unit and a human-machine interface. The control unit comprises a power switch recognizer and a human-machine interface controller. The control unit is configured to collect data from the vehicle to perform machine learning while the power switch is on, and confirm an intention of the user to use the data of the vehicle for machine learning via the human-machine interface.

### CROSS REFERENCE TO RELATED APPLICATIONS

The present disclosure claims the benefit of Japanese Patent Application No. 2020-104956 filed on Jun. 18, 2020 with the Japanese Patent Office, the disclosure of which are incorporated herein by reference in its entirety.

### BACKGROUND

### Field of the Disclosure

Embodiments of the present disclosure relate to the art of a data collection system that collects data for machine learning of an artificial intelligence.

### Discussion of the Related Art

In recent years, an effort has been made to realize a sustainable smart city that is administrated utilizing an artificial intelligence (AI) and an information and communication technology (ICT). The artificial intelligence learns from collected data, and optimizes an output data with respect to an input data based on a learning result (i.e., a learned model). For example, JP-A-2019-183698 describes a vehicle-mounted electronic control unit that is configured to estimate a temperature of an exhaust purification catalyst of an engine using a neural network. According to the teachings of JP-A-2019-183698, an engine speed, an engine load rate, an air-fuel ratio of the engine, an ignition timing of the engine, an HC or CO concentration of exhaust gas flowing into the exhaust purification catalyst, and a temperature of the exhaust purification catalyst are collected, and the collected data is transmitted to an external server. The collected engine speed, engine load rate, air-fuel ratio of the engine, ignition timing of the engine, and HC or CO concentration of the exhaust gas flowing into the exhaust purification catalyst are used as input parameters of the neural network, and the collected temperature of the exhaust purification catalyst is used as training data to learn a weight of the neural network to generate a learned model. The learned model is transmitted from the server to the vehicle. In the vehicle, the electronic control unit predicts the temperature of the exhaust purification catalyst of the engine based on the learned model from the acquired engine speed, the engine load rate, air-fuel ratio of the engine, ignition timing of the engine, and HC or CO concentration of the exhaust gas flowing into the exhaust purification catalyst in the vehicle.

Thus, according to the teachings of JP-A-2019-183698, the temperature of the exhaust purification catalyst is learned based on the data collected by the electronic control unit. An accuracy of such machine learning may be improved to enhance the precision of outputs by collecting more training data from vehicles. However, the training data collected from a vehicle contains sensitive personal information of a driver or owner of the vehicle e.g., a driving record of drivers, and some of the drivers and owners may not be pleased with such usage of personal information for machine learning. In order to protect personal information of the drivers and owners, the training data should be collected and retained more carefully.

### SUMMARY

Aspects of embodiments of the present disclosure have been conceived noting the foregoing technical problems, and it is therefore an object of the present disclosure to provide a data collection system for machine learning that is configured to collect data containing personal information from vehicles while administrating the collected personal information tightly.

The exemplary embodiment of the present disclosure relates to a data collection system that collects data for machine learning from a vehicle, comprising: a control unit that controls the vehicle; and a human-machine interface that offers information to a user of the vehicle, and that is operated by the user. The control unit comprises: a switch recognizer that determines that a power switch of the vehicle is turned on; and a human-machine interface controller that controls the human-machine interface. In order to achieve the above-explained objective, according to the exemplary embodiment of the present disclosure, the control unit is configured to: collect data from the vehicle to perform machine learning while the power switch is on; and confirm an intention of the user to use the data of the vehicle for machine learning via the human-machine interface.

In a non-limiting embodiment, the human-machine interface controller may be configured to indicate a plurality of queries on the human-machine interface.

In a non-limiting embodiment, the queries may include a query to confirm a percentage of the data that is approved by the user to be collected from the vehicle or used for machine learning.

In a non-limiting embodiment, the queries may include a query to confirm a kind of the data that is approved by the user to be collected from the vehicle or used for machine learning.

In a non-limiting embodiment, the control unit may further comprise: an incentive calculator that calculates an incentive compensation to be paid to the user or an owner of the vehicle in accordance with an amount and demand of the data approved by the user to be used for machine learning; and an incentive transmitter that pays the incentive compensation calculated by the incentive calculator to the user or owner.

In a non-limiting embodiment, the incentive compensation may be increased with an increase in the amount of the data used for machine learning.

In a non-limiting embodiment, the incentive compensation may be increased with an increase in the demand of the data that is insufficient to perform machine learning.

Thus, the data collection system according to the exemplary embodiment of the present disclosure is configured to collect data for machine learning from the vehicle upon reception of an approval of the user of the vehicle. Specifically, an intention of the user to collect data from the vehicle is confirmed via the human-machine interface. According to the exemplary embodiment of the present disclosure, therefore, sensitive personal information which is not desirable for the user will not be used to perform machine learning. For this reason, personal information of the user of the vehicle may be protected tightly and administrated carefully.

In addition, according to the exemplary embodiment of the present disclosure, data of the vehicle is used to perform machine learning voluntarily on the user's free will.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle from which data is collected by the data collection system according to the embodiment of the present disclosure;

FIG. 2 is a block diagram showing one example of data transmission between a control unit of the vehicle and a server according to the embodiment of the present disclosure;

FIG. 3 is a flowchart showing one example of a routine executed in the vehicle to receive an approval to collect data from a user of the vehicle;

FIG. 4 is a schematic illustration showing one example of a message to confirm whether the user of the vehicle agrees to transmit data to the server indicated on an HMI device;

FIG. 5 is a schematic illustration showing one example of a message to select an incentive compensation plan indicated on the HMI device;

FIG. 6 is a schematic illustration showing one example of a message to select data transmitted to the server;

FIG. 7 is a flowchart showing one example of a routine executed in the vehicle to calculate the incentive compensation;

FIG. 8 is a flowchart showing one example of a routine executed in the vehicle to transmit training data to the server;

FIG. 9 is a flowchart showing one example of a routine executed in the server to store the training data in the server;

FIG. 10 is a flowchart showing one example of a routine executed in the server to transmit a learned model to the vehicle; and

FIG. 11 is a flowchart showing one example of a routine executed in the vehicle to control the vehicle based on the learned model.

### DETAILED DESCRIPTION OF THE PREFERRED EMBODIMENT(S)

Preferred embodiments of the present application will now be explained with reference to the accompanying drawings.

The data collection system according to the exemplary embodiment of the present disclosure may be applied to conventional vehicles such as a vehicle having an engine, an electric vehicle, a hybrid vehicle, a fuel-cell vehicle, an autonomous vehicle and so on. The data collection system comprises a control unit that is connectable with an external server, and a Human Machine Interface (to be abbreviated as “HMI” hereinafter) that offers information to a user of the vehicle.

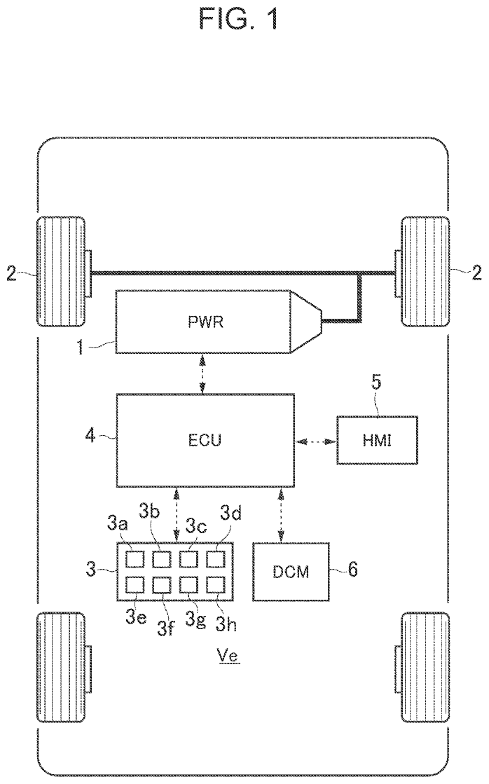

Turning to FIG. 1, there is shown one example of a structure of the vehicle to which the data collection system according to the exemplary embodiment of the present disclosure is applied. The vehicle Ve shown in FIG. 1 comprises a prime mover (referred to as “PWR” in FIG. 1) 1, a pair of drive wheels 2, a detector 3, a control unit (referred to as “ECU” in FIG. 1) 4, an HMI 5, and a communication module (referred to as “DCM” in the drawings) 6.

The prime mover 1 generates a drive torque to establish a drive force to propel the vehicle Ve. For example, an internal combustion engine such as a gasoline engine and a diesel engine may be adopted as the prime mover 1. An output power of the engine may be adjusted electrically, and the engine may be started and stopped electrically according to need. Given that the gasoline engine is adopted as the prime mover 1, an opening degree of a throttle valve, an amount of fuel supply or fuel injection, a commencement and a termination of ignition, and an ignition timing etc. may be controlled electrically. Otherwise, given that the diesel engine is adopted as the prime mover 1, an amount of fuel injection, and an injection timing, an opening degree of a throttle valve of an EGR (Exhaust Gas Recirculation) system etc. may be controlled electrically.

Instead, a permanent magnet type synchronous motor and an induction motor may also be adopted as the prime mover 1. Those kinds of motors may serve not only as a motor to generate torque when driven by electricity suppled thereto, but also as a generator to generate electricity when rotated by a torque applied thereto. That is, a motor-generator may also be adopted as the prime mover 1. In this case, the prime mover 1 is switched between a motor and a generator by electrically controlling the prime mover 1, and an output speed and an output torque of the prime mover 1 may be controlled electrically.

In the vehicle Ve shown in FIG. 1, a pair of front wheels serve as drive wheels 2, and a drive torque generated by the prime mover 1 is delivered to the drive wheels 2 to propel the vehicle Ve. However, the data collection system according to the embodiment of the present disclosure may also be applied to a rear-drive layout vehicle in which a pair of rear wheels serve as drive wheels and a four-wheel drive vehicle in which all of the wheels are driven by the prime mover 1. In a case of employing the engine as the prime mover 1, a transmission (not shown) may be arranged downstream of the prime mover 1 to deliver the output torque of the prime mover 1 to the drive wheels 2 via the transmission. Each of the front wheels and rear wheels is individually provided with a brake device (not shown), and any one of the pairs of the front wheels and the rear wheels is connected to a steering device (not shown).

The vehicle Ve further comprises an accelerator pedal that controls the drive force, a brake pedal that control a brake force, and a navigation system (none of which are shown). The navigation system is configured to determine a travelling route of the vehicle Ve based on positional information obtained by a GPS receiver 3h and a map database, and a current location of the vehicle Ve is indicated on the navigation system. Instead, a navigation application of a mobile terminal may also be used in combination with the data collection system.

The detector 3 includes a power source, a microcomputer, various kinds of sensors, an input-output interface and so on, and the detector 3 collects various kinds of data and information to control the vehicle Ve. According to the embodiment of the present disclosure, the detector 3 comprises: a vehicle speed sensor 3a that detects a speed of the vehicle Ve; a rotational speed sensor 3b that detects a rotational speed of the prime mover 1; an accelerator sensor 3c that detects a position of the accelerator pedal; a brake switch 3d that detects an activation of the brake device; a steering sensor 3e that detects an angle of a steering device (not shown); a temperature sensor 3f that detects a temperature of an exhaust gas purifying catalyst; an on-board camera 3g that records information about an external condition; and the above-mentioned GPS receiver 3h that obtains a location (i.e., latitude and longitude) of the vehicle Ve based on incident signals from GPS satellites. The detector 3 is electrically connected to the control unit 4 so that detection values obtained by those sensors are transmitted to the control unit 4 in the form of electric signal.

Specifically, the control unit 4 is an electronic control unit comprising a microcomputer. In order to control the vehicle Ve, the data collected by the detector 3 is sent to the control unit 4, and the control unit 4 performs calculation using the incident data transmitted from the detector 3, as well as data and formulas stored in advance. Calculation results are transmitted from the control unit 4 to control the vehicle Ve in the form of command signal. Optionally, a plurality of the control units 4 may be arranged in the vehicle Ve according to need.

According to the exemplary embodiment of the present disclosure, data is transmitted between the control unit 4 and an external server 7 so that the control unit 4 performs machine learning in cooperation with the server 7. Specifically, the data detected or computed by the detector 3 is transmitted from the control unit 4 to the server 7, and the data transmitted to the server 7 is analyzed by the server 7 to build a learned model. The learned model is transmitted from the server 7 to the control unit 4 so that each part of the vehicle Ve may be controlled by the control unit 4 based on the learned model.

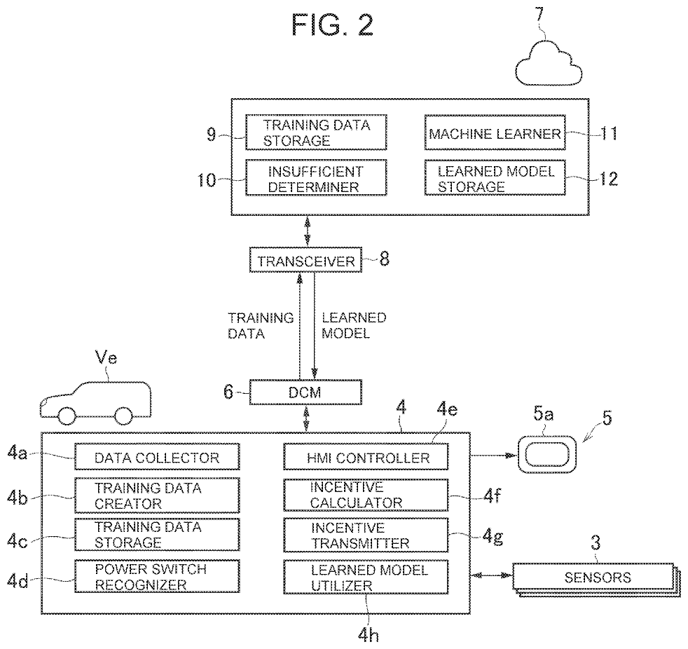

As shown in FIG. 2, the control unit 4 comprises a data collector 4a, a training data creator 4b, a training data storage 4c, a power switch recognizer 4d, an HMI controller 4e, an incentive calculator 4f, an incentive transmitter 4g, and a learned model utilizer 4h. Although only one vehicle is depicted in FIG. 2, the server 7 may collect data from a plurality of vehicles and may transmit data to a plurality of vehicles. In order to improve accuracy of machine learning performed by the server 7, it is preferable to collect data as much as possible. To this end, the server 7 collects data from a plurality of the control units 4 mounted on vehicles.

During propulsion of the vehicle Ve, the detector 3 detects desired data for machine learning of the server 7. The data detected by the detector 3 is transmitted to the control unit 4, and the data collector 4a associates the data transmitted from the detector 3 with a detected time, a detected region, a driver, and so on.

The training data creator 4b creates a training data for machine learning of the server 7 based on the data associated with the above-mentioned parameters by the data collector 4a, and the training data created by the training data creator 4b is transmitted to the server 7. The training data created by the training data creator 4b is also stored in the training data storage 4c of the control unit 4.

The power switch recognizer 4d determines that the power switch is turned on to activate the vehicle Ve.

The HMI controller 4e controls the HMI 5 based on information exchanged between the driver or a passenger (as will be commonly referred to as “user” hereinafter) of the vehicle Ve and the control unit 4. Specifically, the HMI 5 indicates e.g., a text message to transmit information to the user based on an information signal transmitted from the HMI controller 4e to the HMI 5.

The incentive calculator 4f calculates an incentive compensation to be paid to the user or an owner of the vehicle Ve, in accordance with an amount and demand of data approved by the user to be used as the training data.

The incentive transmitter 4g pays the incentive compensation calculated by the incentive calculator 4f to the user or owner in an economically valuable form such as currency, point, digital coin or the like.

The learned model utilizer 4h controls the vehicle Ve based on a learned model transmitted thereto from the server 7. According to the data collection system of the exemplary embodiment, the server 7 performs machine learning in cooperation with the control unit 4 of the vehicle Ve. Specifically, the data collection system is configured to perform supervised learning utilizing neural networks to build a model. The learned model built by the server 7 is transmitted to the control unit 4 of the vehicle Ve so that the learned model utilizer 4h controls the vehicle Ve based on the learned model.

The HMI 5 as a human-machine interface or a user interface offers information to the user of the vehicle Ve, and is operated by the user. Specifically, the HMI 5 comprises a display 5a as a touch screen or a touch panel that is operated by the user. Optionally, the HMI 5 may be provided with a speaker (not shown) that offers information to the user phonically by a voice message or acoustically by a sound or tone. In addition, the HMI 5 may be further provided with sensors such as a proximity sensor, a motion sensor, an infrared sensor and so on; a voice-entry system; and an operating switch and an operating button (neither of which are shown). For example, a display (not shown) of the navigation system may be adopted as the display 5a.

Thus, the HMI 5 is configured to sense touch instructions, voice instructions, gestural instructions of the user via the display 5a, and transmits command signals to the control unit 4 based on the instructions of the user. Whereas, the information transmitted from the control unit 4 is conveyed to the user via a text message or image indicated on the display 5a, or a voice or sound message.

The signals are transmitted wirelessly between the control unit 4 of the vehicle Ve and the server 7 through the communication module 6. Specifically, the communication module 6 comprises a communication device (not shown), and transmits and receives data to/from an after-mentioned transceiver 8 of the server 7 through a dedicated communication line. Instead, the data may also be transmitted between the communication module 6 and the transceiver 8 of the server 7 using a communication line of a mobile communications network. Especially, according to the exemplary embodiment of the present disclosure, the communication module 6 transmits data for machine learning to the server 7.

As illustrated in FIG. 2, the server 7 is installed on a predetermined site. Specifically, the server 7 comprises the aforementioned transceiver 8 as a communication device, a training data storage 9, an insufficient data determiner 10, a machine learner 11, and a learned model storage 12.

The transceiver 8 receives data for machine learning transmitted from the control unit 4 through the communication module 6, and the learned model built as a result of preforming machine learning is transmitted from the transceiver 8 to the control unit 4 of the vehicle Ve. Here, it is to be noted that data other than the data for machine learning and the learned model may also be transmitted between the transceiver 8 and the control unit 4.

The training data transmitted from the control unit 4 and data computed by the server 7 are stored in the training data storage 9 to create a database.

The insufficient data determiner 10 determines what kind of data is insufficient to build a learned model using the neural networks. For example, the insufficient data determiner 10 determines that data relating to a temperature of the catalyst is insufficient, or that data relating to a driving pattern of twenty-something male drivers. The information about the insufficient data is transmitted from the server 7 to the vehicle Ve so that the user is allowed to select acceptable data to be used for machine learning based on the recognition of the insufficient data.

The machine learner 11 performs machine learning based on the data collected from a plurality of vehicles Ve. For example, the data collected to the vehicle Ve is used as the training data, and the learned model for controlling the vehicle Ve is built by the artificial neural network. That is, the machine learner 11 is configured to perform supervised learning. In a case of performing supervised learning, a deep learning method may be employed. Instead, the machine learner 11 may also preform unsupervised learning. To this end, the machine learner 11 repeatedly analyses characteristics and tendency of the data collected from the vehicle Ve, and the vehicle Ve is controlled based on the analysis result. In addition, the machine learner 11 may also perform semi-supervised learning utilizing not only a labeled data determined by supervised learning but also an unlabeled data learned by the unsupervised learning, and reinforcement learning to improve the accuracy of machine learning by a trial-and-error process.

The learned model built by the machine learner 11 is stored in the learned model storage 12 to create a database.

Thus, the server 7 performs machine learning to control the vehicle Ve comprehensively based on the data collected from the control unit 4 of the vehicle Ve. Accuracy of machine learning thus performed by the server 7 may be improved by collecting data from a plurality of the vehicles Ve as much as possible, and consequently the vehicle Ve may be controlled properly based on the output of the server 7. However, the training data built based on the data collected from the vehicles Ve contains sensitive personal information of the user or owner, and some of the users and owners may not be pleased with such usage of personal information for machine learning. According to the exemplary embodiment of the present disclosure, therefore, the data collection system is configured to obtain approval of the user of the vehicle Ve to use the data for machine learning.

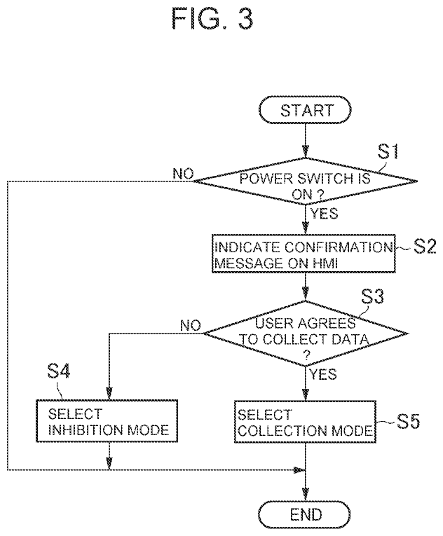

Turning to FIG. 3, there is shown one example of a routine to confirm whether the user of the vehicle Ve agrees to transmit the data collected from the vehicle Ve to the server 7. At step S1, it is determined whether the power switch (i.e., power switch) is turned on. That is, at step S1, it is determined whether the HMI 5 is in a condition possible to indicate a message based on the data transmitted from the server 7 to the vehicle Ve. For example, given that the vehicle Ve is an engine vehicle, such determination at step S1 may be made based on a fact that an ignition key is turned. Otherwise, given that the vehicle Ve is a hybrid vehicle or an electric vehicle, such determination at step S1 may be made based on a fact that the vehicle Ve is in a ready-on state.

If the power switch is off so that the answer of step S1 is NO, the routine returns without carrying out any specific control.

By contrast, if the power switch has been turned on so that the answer of step S1 is YES, the routine progresses to step S2 to indicate a message to confirm whether the user of the vehicle Ve agrees to transmit the data about the vehicle Ve to the server 7 on the HMI 5. That is, at step S2, an intention of the user to send the data about the vehicle Ve to the server 7 to train the server 7 is confirmed via the HMI 5.

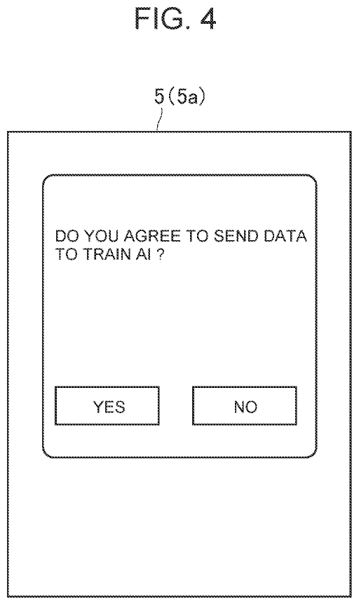

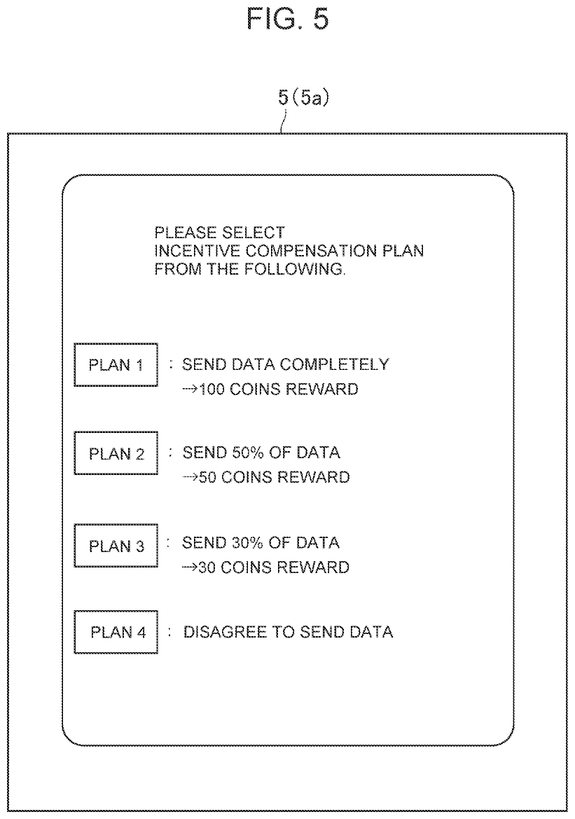

Examples of queries indicated on the HMI 5 are shown in FIGS. 4 to 6. First of all, as shown in FIG. 4, the message to confirm whether the user of the vehicle Ve agrees to transmit the data about the vehicle Ve to the server 7 is indicated on the HMI 5. According to the exemplary embodiment of the present disclosure, the user or owner of the vehicle Ve is rewarded in accordance with an amount of data transmitted to the server 7, and an incentive compensation plan may be selected from plans shown in FIG. 5. For example, if the user agrees to transmit the data collected during propulsion of the vehicle Ve completely to the server 7, Plan 1 is applicable. In this case, the data transmitted to the server 7 is entirely converted into e.g., digital coin, and paid to the user. If the user agrees to transmit 50% of the data collected during propulsion of the vehicle Ve to the server 7, Plan 2 is applicable. In this case, 50% of the data transmitted to the server 7 is converted into e.g., digital coin, and paid to the user. If the user agrees to transmit 30% of the data collected during propulsion of the vehicle Ve to the server 7, Plan 3 is applicable. In this case, 30% of the data transmitted to the server 7 is converted into e.g., digital coin, and paid to the user. If the user does not agree to transmit the data collected during propulsion of the vehicle Ve to the server 7, Plan 4 is applicable. In this case, the user will not be rewarded. Here, it is to be noted that a percentage of the data transmitted to the server 7 in each of the above-mentioned plans may be altered arbitrarily.

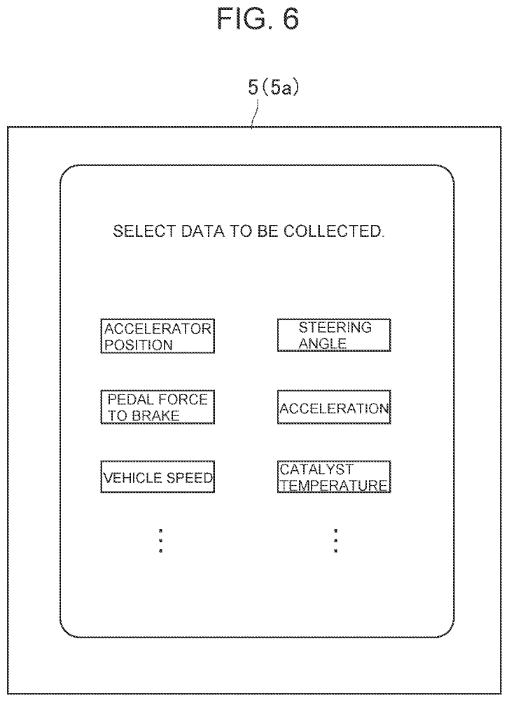

In addition, according to the exemplary embodiment of the present disclosure, the user of the vehicle Ve is allowed to select data sent to the server 7. For example, as shown in FIG. 6, the data to be transmitted from the vehicle Ve to the server 7 is categorized into a position of the accelerator pedal, a steering angle, a pedal force applied to the brake pedal, an acceleration of the vehicle Ve, a speed of the vehicle Ve, a temperature of the catalyst etc., and the user of the vehicle Ve is allowed to select data to be collected by the collection system. As explained later, an exchange rate from the data to the compensation may be altered in accordance with an amount and demand of the data transmitted to the server 7.

Then, it is determined at step S3 whether the user agrees to collect data through the HMI 5. Specifically, if the user agrees to transmit the data of the vehicle Ve to the server 7 via the HMI 5 at step S2, the answer of step S3 will be YES. For example, if the user does not agree to transmit the data of the vehicle Ve to the server 7 via the HMI 5 at step S2 so that the answer of step S3 is NO, the routine progresses to step S4 to select an inhibition mode in which a collection of the training data from the vehicle Ve is inhibited, and thereafter the routine returns.

By contrast, if the user agrees to transmit the data of the vehicle Ve to the server 7 via the HMI 5 at step S2 so that the answer of step S3 is YES, the routine progresses to step S5 to select a collection mode in which the training data is transmitted from the vehicle Ve to the server 7, and thereafter the routine returns. In this case, the incentive compensation plan may be selected from e.g., the above-mentioned plans shown in FIG. 5, and the data transmitted to the server 7 may be selected from e.g., the above-mentioned options shown in FIG. 6.

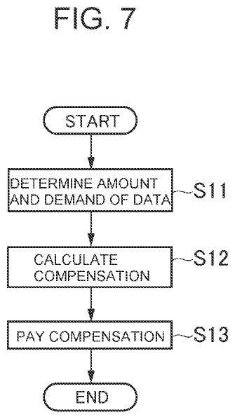

Next, here will be explained one example of procedure to calculate the incentive compensation with reference to FIG. 7. As described, the incentive compensation may be calculated in accordance with an amount and demand of the data transmitted to the server 7, and the incentive compensation may be paid to the user or owner in an economically valuable form such as currency, points, digital coins, coupons and so on.

At step S11, an amount and demand (or value) of the data collected from the vehicle Ve are determined. As described, according to the exemplary embodiment of the present disclosure, kind of the data to be transmitted from the vehicle Ve to the server 7 may be selected by the user, and demand of the data about the vehicle Ve changes continuously. That is, data about certain kind of parameter insufficient to build the learned model of the parameter accurately is more valuable than data about other parameters which have been collected sufficiently to build learned models. For example, if data about a position of the accelerator pedal is insufficient to build a learned model of an accelerator position accurately, the data about a position of the accelerator pedal is more valuable than data about other parameters which have been collected sufficiently to build learned models of the other parameters. In order to allow the user to select the data to be transmitted to the server 7 at step 3 of the above-explained routine shown in FIG. 3, information about the data currently stored in the server 7 is indicated on the HMI 5. In other words, the user may confirm what kind of data is insufficient to build the learned model, based on the information transmitted to the HMI 5 from the server 7.

Then, at step S12, the incentive compensation to be paid to the user or owner is calculated with reference to e.g., a three-dimensional map determining a relation among an amount of the data transmitted to the server 7, demand of the data, and the incentive compensation. Specifically, the higher incentive compensation will be paid with an increase in the amount of the data transmitted to the server 7 and an increase in the demand of the data.

Thereafter, at step S13, the incentive compensation is paid to the user or owner in the amount calculated at step S12. For example, if the user or owner wishes to receive the incentive compensation by a monetary payment, the incentive compensation may be paid into a bank account of the user or owner. Instead, the incentive compensation may also be paid in the form of virtual currency or points to the user or owner though a specific application installed on a smartphone or the like.

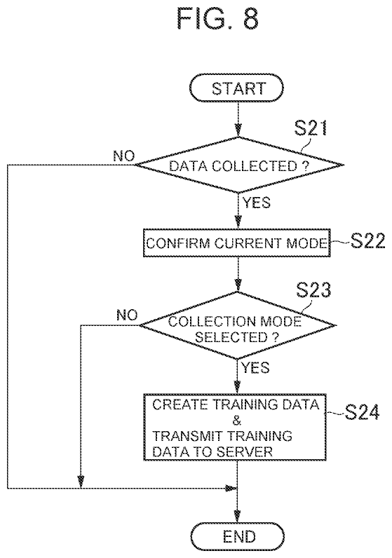

Here will be explained procedures to transmit the training data from the vehicle Ve to the server 7 with reference to FIG. 8. At step S21, it is determined whether the data about the vehicle Ve has been collected. Specifically, the data about the vehicle Ve is collected by the detector 3, and the data collected by the detector 3 is associated with personal information of the user. For example, the data collected by the detector 3 is associated with information about who drove the vehicle Ve, information about when the vehicle Ve was driven, information about which route the vehicle Ve traveled, information about a traveling pattern of the vehicle Ve and so on.

If the data about the vehicle Ve has not yet been collected so that the answer of step S21 is NO, the routine returns. By contrast, if the data about the vehicle Ve has been collected so that the answer of step S21 is YES, the routine progresses to step S22 to confirm which of the modes explained at steps S4 and S5 of the routine shown in FIG. 3 is currently selected. Specifically, at step S22, it is confirmed that the inhibition mode is currently selected or that the collection mode is currently selected.

Then, it is determined at step S23 whether the collection mode is currently selected. If the collection mode is currently selected so that the answer of step S23 is YES, the routine progresses to step S24 to create the training data based on the data collected by the detector 3, and to transmit the training data to the server 7.

By contrast, if the inhibition mode is currently selected so that the answer of step S23 is NO, the routine returns.

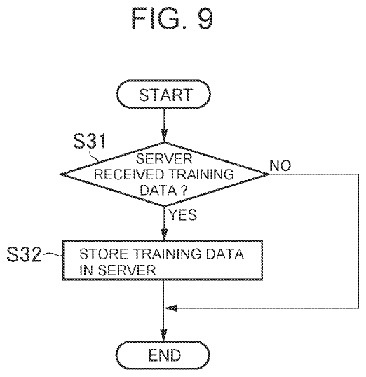

Next, here will be explained routines to be executed in the server 7 will be explained. First of all, procedures to store the training data transmitted from the vehicle Ve in the server 7 will be explained with reference to FIG. 9. At step S31, it is determined whether the server 7 receives the training data transmitted from the vehicle Ve. If the server 7 has not yet received the training data so that the answer of step S31 is NO, the routine returns.

By contrast, if the server 7 has received the training data so that the answer of step S31 is YES, the routine progresses to step S32 to store the training data in the server 7. Thereafter, the routine returns.

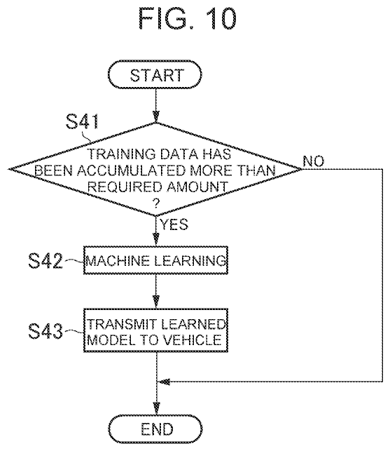

Upon reception of the training data, the server 7 executes a routine shown in FIG. 10 to perform machine learning and to send a created learned model to the vehicle Ve.

At step S41, it is determined whether the training data has been accumulated more than a predetermined amount to perform machine learning. Specifically, a required amount of the training data about a certain parameter to accurately create the learned model of the parameter is set in advance, and the answer of step S41 will be YES if the training data about the parameter has already been accumulated in the server 7 in a greater amount than the required amount. If the training data has not yet been accumulated in the required amount in the server 7 so that the answer of step S41 is NO, the routine returns.

By contrast, if the training data has already been accumulated in the required amount in the server 7 so that the answer of step S41 is YES, the routine progresses to step S42 to perform machine learning using the neural network based on the training data collected from the vehicle Ve. As a result of performing the machine learning, a learned model is built.

That is, according to the exemplary embodiment of the present disclosure, the server 7 preforms a supervised learning at step S42 based on the training data. Then, at step S43, the learned model built as a result of performing supervised learning is transmitted from the server 7 to the control unit 4 of the vehicle Ve. Thereafter, the routine returns.

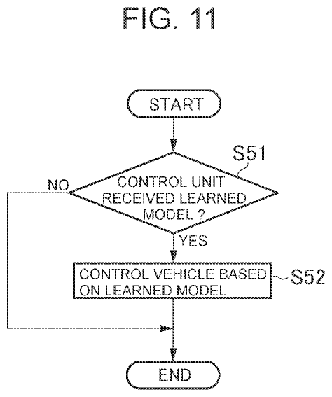

In response to a transmission of the learned model to the vehicle Ve, the control unit 4 of the vehicle Ve executes a routine shown in FIG. 11 to control the vehicle Ve based on the learned model. At step S51, it is determined whether the control unit 4 receives the learned model transmitted from the server 7. If the control unit 4 has not yet received the learned model so that the answer of step S51 is NO, the routine returns.

By contrast, if the control unit 4 has received the learned model so that the answer of step S51 is YES, the routine progresses to step S52 to control the vehicle Ve based on the learned model. Specifically, the learned model stored in the control unit 4 is updated to the latest learned model transmitted from the server 7, and the vehicle Ve is controlled based on the updated learned model. Thereafter, the routine returns.

Thus, the data collection system according to the exemplary embodiment of the present disclosure is configured to receive an approval to collect data from the user of the vehicle Ve to train the server 7. Specifically, an approval of the user to collect data from the vehicle Ve is transmitted to the server 7 via the HMI 5. According to the exemplary embodiment of the present disclosure, therefore, sensitive personal information which is not desirable for the user will not be sent to the server 7. For this reason, personal information of the user of the vehicle Ve may be protected tightly and administrated carefully.

As described, according to the exemplary embodiment of the present disclosure, the approval of the user to collect data from the vehicle Ve is transmitted to the server 7 via the HMI 5. In addition, the information transmitted from the server 7 may be indicated on the HMI 5 in the form of e.g., text message. According to the exemplary embodiment of the present disclosure, therefore, the user is allowed to select the incentive compensation plan from a plurality of options by operating the HMI 5. Further, the user is allowed to send only the desired data to the server 7. Thus, according to the exemplary embodiment of the present disclosure, data of the vehicle Ve is sent voluntarily to the server 7 on the user's free will.

As also described, according to the exemplary embodiment of the present disclosure, the user of the vehicle Ve is rewarded in accordance with an amount and demand of the data transmitted to the server 7. According to the exemplary embodiment of the present disclosure, therefore, the user is motivated to send the data of the vehicle Ve to train the server 7 so that the learned model is built by the server 7 promptly and accurately.

Although the above exemplary embodiments of the present disclosure have been described, it will be understood by those skilled in the art that the present disclosure should not be limited to the described exemplary embodiments, and various changes and modifications can be made within the scope of the present disclosure. For example, the information transmitted from the server 7 may also be projected on a windshield glass though a head-up display instead of the HMI 5. In addition, transmission of data about a parameter used frequently to control the vehicle Ve may be confirmed not only when turning on the power switch of the vehicle Ve but also at predetermined time intervals. By contrast, in order not to bother the user, data about a parameter used not so frequently to control the vehicle Ve may be confirmed only when turning on the power switch of the vehicle Ve.

Further, an intention of the user to send the data to the server 7 may also be confirmed after collecting the data from the vehicle Ve and storing the collected data in the control unit.

What is claimed is:

1. A data collection system that collects data used for machine learning from a vehicle:
wherein the data includes personal information of a user of the vehicle, the data collection system comprising:
a control unit that controls the vehicle; and
a human-machine interface that offers information to the user of the vehicle, and that is operated by the user,
wherein the control unit comprises a switch recognizer that determines that a power switch of the vehicle is turned on, and a human-machine interface controller that controls the human-machine interface, and
the control unit is configured to
confirm at least one of an intention of the user to use the data of the vehicle for machine learning and an intention of the user to collect the data of the vehicle for machine learning, via the human-machine interface.

2. The data collection system as claimed in claim 1, wherein the data associated with the intention of the user that is confirmed includes data relating to the personal information of the user.

3. The data collection system as claimed in claim 1, wherein the human-machine interface is configured to indicate a plurality of queries on the human-machine interface.

4. The data collection system as claimed in claim 3, wherein the queries include a query to confirm a percentage of the data that is approved by the user to be collected from the vehicle or used for machine learning.

5. The data collection system as claimed in claim 3, wherein the queries include a query to confirm a kind of the data that is approved by the user to be collected from the vehicle or used for machine learning.

6. The data collection system as claimed in claim 1, wherein the control unit further comprises:
an incentive calculator that calculates an incentive compensation to be paid to the user or an owner of the vehicle in accordance with an amount and demand of the data approved by the user to be used for machine learning; and
an incentive transmitter that pays the incentive compensation calculated by the incentive calculator to the user or the owner.

7. The data collection system as claimed in claim 6, wherein the incentive compensation is increased with an increase in the amount of the data used for machine learning.

8. The data collection system as claimed in claim 6, wherein the incentive compensation is increased with an increase in the demand of the data that is insufficient to perform machine learning.
